(19) United States
(12) Patent Application Publication
(10) Pub. No.: US 2024/0035289 A1
(43) Pub. Date: Feb. 1, 2024

(54) Lighting System

(71) Applicant: DefineLine Systems Ltd, Macclesfield, Cheshire (GB)

(72) Inventors: Kevin Tattersall, Macclesfield, Cheshire (GB); Christopher Paul Frank Shepard, Macclesfield, Cheshire (GB)

(21) Appl. No.: 18/275,569

(22) PCT Filed: Jan. 28, 2022
(86) PCT No.: PCT/GB2022/000011

§ 371 Date: Aug. 2, 2023

(30) Foreign Application Priority Data
Feb. 3, 2021 (GB) 2101510.2

(51) Int. Cl. E04F 19/06; F21V 33/00; F21V 15/01; F21Y 115/20

(52) U.S. Cl. CPC E04F 19/061; F21V 33/006; F21V 15/013; F21Y 2115/20

(57) ABSTRACT

A lighting system has an elongate bracket having a recess for receiving an edge of a wall member in use such that the bracket extends along the edge of the wall member; a groove extending along the length of the bracket and spaced from the rear wall by an intermediate wall portion; and an electroluminescent wire extending along the length of the bracket at a position within the groove in front of the rear wall such that the electroluminescent wire is exposed in use.

The present invention relates to a lighting system, particularly to an edge lighting system and support bracket therefor.

“Edge lighting” is used to illuminate the corners or other vertices of rooms. This may give the room a modern or futuristic feel, as the edges of the room are “highlighted”. In a typical configuration, a strip of LEDs is placed onto a top edge of the skirting or coving. Alternatively, the LED strip may be attached directly to the wall, ceiling or floor adjacent to the vertex.

The inventor has found numerous problems with prior art edge lighting systems. When not illuminated, the LED strips are clearly visible and thus not aesthetically pleasing. The LEDs on the strip are provided as discrete light sources. The LEDs thus project discrete portions of light onto the walls. Again, this may not be aesthetically pleasing and may ruin the edge effect. Furthermore, the LEDs are typically fixed using fasteners or adhesives etc. This makes the strip difficult to replace and may cause permanent damage to the walls, covings etc, when installing or removing.

The term ‘shadow gap’ has become widely used in architectural terminology to define a gap provided between two surfaces, typically in internal rooms of a property. Gaps of this kind are purposely provided so that the interface between the two surfaces is recessed, and therefore hidden from normal sight. This gives the impression that the two surfaces are ‘floating’ rather than being abutted at a corner. This effect is becoming popular to provide a clean and premium finish within homes and other premises. As well as being provided adjacent to features such as skirtings, door frames, window frames and the like, shadow gaps may also be provided between a wall and a ceiling or adjacent walls.

In rooms where significant effort has been expended to provide shadow gaps, it can detract from the aesthetic if conventional LED strips are used to illuminate the gaps for the reasons described above.

It is an aim of the present inventive to overcome or ameliorate one or more of the above problems. It may be considered an aim of the invention to provide an edge lighting system that can offer an improved aesthetic effect.

According to a first aspect of the invention, there is provided a lighting system comprising an elongate bracket having a recess having a rear wall for receiving an edge of a wall member in use such that the bracket extends along the edge of the wall member; a groove extending along the length of the bracket and spaced from a rear wall by an intermediate wall portion; and an electroluminescent wire extending along the length of the bracket within the groove in front of the rear wall such that the electroluminescent wire is exposed in use.

The electroluminescent wire thus sits proud of the rear wall in use to provide a particularly cleanly/sharply lit edge when a wall member is located in front of the rear wall.

The bracket may comprise a facia extending from the recess and comprising an outer engagement surface configured to support a decorative surface over the facia.

The engagement surface may be configured to support hardenable plaster in use.

The engagement surface may comprise a keying surface. The engagement surface may comprise one or more keying formations, such as ribs, channels or grooves.

Optional features of the invention are defined in the appended claims 2-25.

The invention allows a defined edge or line to be more accurately lit using an electroluminescent wire held at a predetermined position along the bracket, thereby defining a particularly sharp illuminated edge or vertex of a wall. The electroluminescent wire may be accompanied by a further light source on the bracket, e.g. to provide a more diffuse/volumetric lighting effect.

The effect of using an electroluminescent wire along the bracket allows architectural features to be ‘drawn’ or highlighted in use by electrical activation of the wire. Architectural features such as edges, vertices, recesses, window/door frames and/or shadow gaps associated therewith can be defined more precisely and in a more striking manner. This can highlight a room in a manner that has not been hitherto possible.

Furthermore, the system may allow for illumination of individual lengths of the bracket, thereby allowing different edges/vertices or other architectural features to be illuminated independently. This can allow highlighting of individual features or a sequence of features, e.g. akin to animating a room. That is to say individual features can be highlighted in a sequence, thereby recreating those features line by line using light. The sequence can be predetermined, variable (e.g. according to a number of preset patterns) or randomized as desired. This can create a particularly striking effect for highlighting the architectural features of a room in an animated manner, e.g. where a room can be ‘redrawn’ in light in the eyes of a viewer.

The electroluminescent wire may be provided along a distal edge of the bracket.

The bracket may define an edge of a shadow gap in use. The electroluminescent wire may define an edge of a shadow gap in use.

The bracket may define the depth/width of a shadow gap.

The intermediate wall may define a depth of the bracket.

The bracket may have both front and rear walls and the intermediate wall may extend there-between. A depth of the bracket between the front and rear walls (e.g. a height of the intermediate wall) may define at least a portion of a depth of the shadow gap. Additionally or alternatively, the rear wall may extend beyond a distal/free edge of the front wall, e.g. into or across the shadow gap. The rear wall may define a rear wall of the shadow gap.

The invention is well-suited to illuminating shadow gaps in a way that is particularly clean, sharp and visually striking.

Workable embodiments of the invention are described in further detail below with reference to the accompanying drawings, of which:

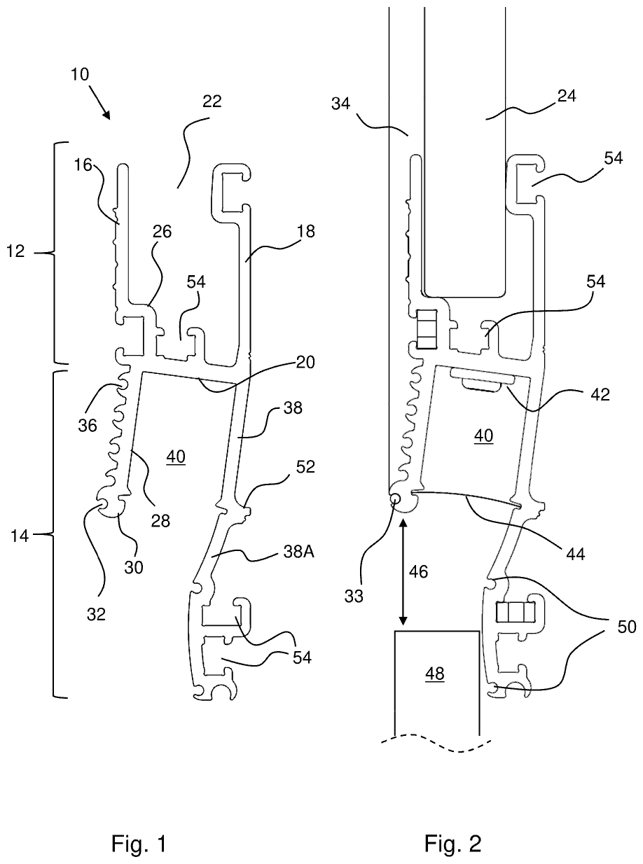

FIG. 1 shows a cross section view of an example of a bracket according to the invention;

FIG. 2 shows an example of the bracket of FIG. 1 in use;

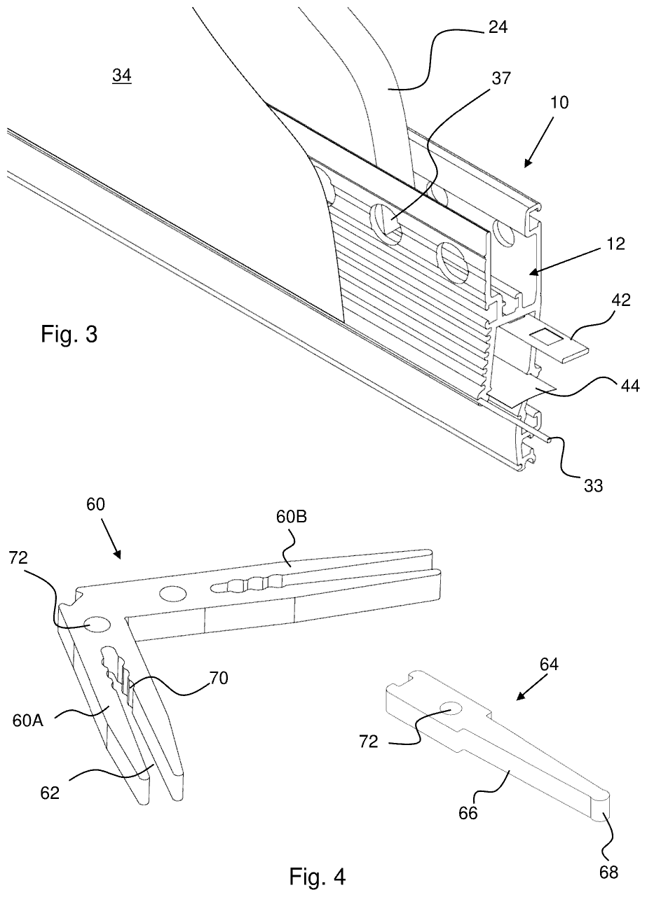

FIG. 3 shows a three-dimensional, part-cut-away view of the arrangement of FIG. 2 without the opposing member 48;

FIG. 4 shows a three dimensional view of fastener members for attaching lengths of brackets together;

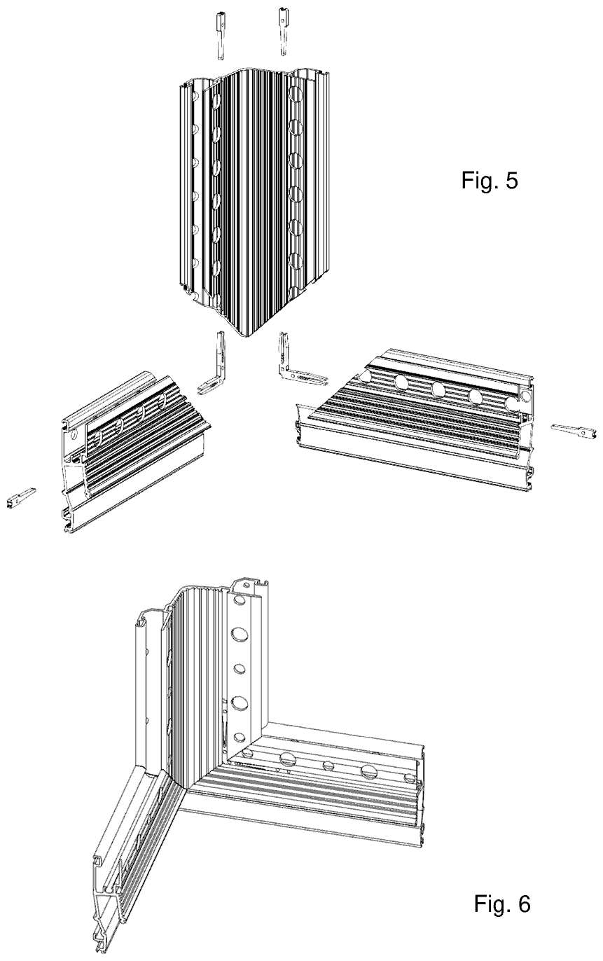

FIG. 5 shows an example of an exploded joint between three brackets to show examples of the fastener members;

FIG. 6 shows an example of an assembled joint;

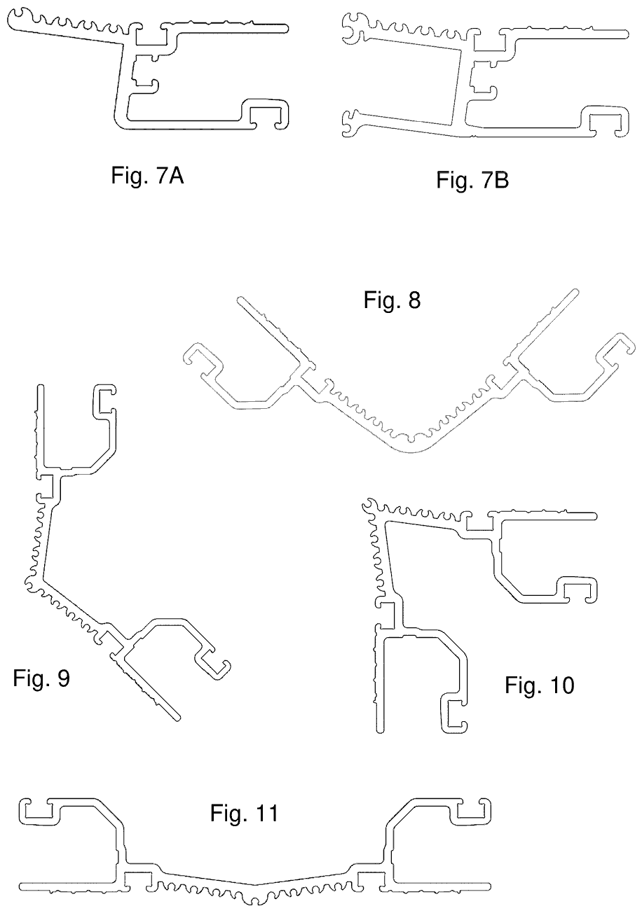

FIGS. 7-11 show example cross sectional views of different brackets for use in a system according to the invention;

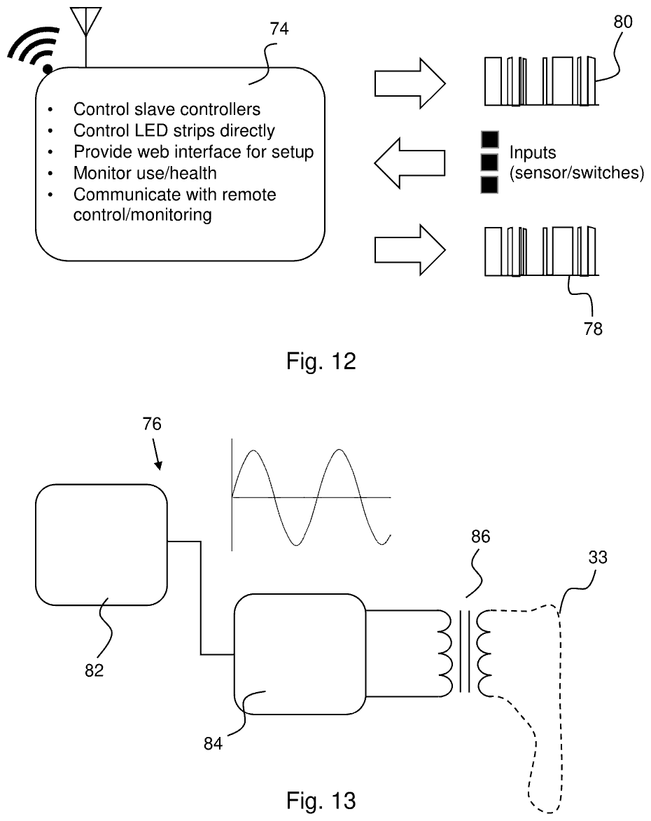

FIG. 12 shows a schematic of a main controller for a lighting system according to an example of the invention;

FIG. 13 shows a schematic of a controller for an individual length of a lighting system according to an example of the invention.

Turning firstly to FIGS. 1-3, there is shown an elongate bracket member 10 for use in a lighting system. The bracket 10 is formed as an elongate component having a constant cross-sectional profile along its length. The bracket may be formed as a long/continuous length that is subsequently cut to a desired length. Alternatively, desired discrete lengths of the bracket can be formed. The bracket may be formed using an extrusion process.

The bracket member 10 in this example is formed of metal, e.g. aluminium, although in other examples it could comprise a different metal/alloy or else may be formed of plastics material or a composite material. The bracket member may be anodized.

The bracket has a bespoke and multifunction profile as will be described below.

A first portion of the profile comprises a recess 12. The recess 12 is generally U-shaped and has front 16 and rear 18 walls spaced at one end by an intermediate wall 20. The intermediate wall 20 defines a closed end of the recess 12, whilst the opposing end 22 is open.

The open end 22 is arranged to receive a wall member 24 as shown in FIGS. 2 and 3, such that an edge of the wall member 24 enters the recess and becomes lodged therein. In this way the bracket lies along the edge of the wall member 24 in use and provides a flange formation for attachment of other components to the wall member as will be described herein.

The edge of the wall member 24 may abut a shoulder formation 26 in the recess, e.g. a shoulder portion of the intermediate wall 20, which may define an end stop for the wall member 24. In other examples, the wall member could abut against a flat portion of the intermediate wall 20, i.e. if no other abutment formation is present in the recess.

The wall member 24 may be a close fit in the recess 12, e.g. with the opening 22 or recess 12 height being approximately equal to the wall thickness of the wall member 24.

The wall member 24 is typically a plasterboard of conventional type but could be any other suitable wall member, if desired, such as a different type of board member suitable for defining a wall/ceiling structure of a room of a building. The lighting system is intended for internal use but could potentially be used for external use, i.e. exterior surfaces, of a structure if desired. Cement board could be used in other examples.

In other examples, the front wall 16 may not be present, e.g. a wall member 24 may be inserted into an open-sided recess defined by the rear wall 18 and intermediate wall 20. Such an arrangement may be suitable for a dry-line installation in which it is not required to plaster over the wall member 24 to provide the required finish.

In some examples, the wall member 24 may not comprise a board member. The wall member 24 may be applied as render, which hardens in situ. In such examples, the front wall 16 may be absent such that render can be applied up to the intermediate wall when the bracket is in place.

A second portion 14 of the bracket is arranged to support lighting members, i.e. to hold one or more light-emitting member in position relative to the intermediate wall 20 and/or the edge of the wall member 24 in use.

The second portion 14 of the bracket 10 extends from the opposing side of the intermediate wall 20 from the recess 12.

The second portion 14 comprises a frontal wall 28. The frontal wall depends from the intermediate wall 20 and/or a proximal end of the front wall 16 to a distal edge 30. Running along the distal edge 30, there is provided a groove 32.

The groove receives a light emitting wire 33 as shown in FIGS. 2 and 3, i.e. electroluminescent (EL) wire. The EL wire thus runs along the length (e.g. typically the full length) of the elongate bracket member 10 in use.

The frontal wall 28 is front facing in the same manner as the front wall 16. However the frontal wall 28 is angled slightly such that the walls 26 and 28 are noy perfectly coplanar. The frontal wall 28 is angled forwardly slightly. This allows for the application of a layer of plaster (see FIGS. 2 and 3) over the walls 16 and 28 in use. The depth of the layer of plaster 34 will thus taper slightly towards the groove 32 at the distal edge.

The groove 32 at the distal edge 30 is provided in an edge bead formation that protrudes forwardly of the frontal wall 28. This provides a boundary for plastering such that a plasterer can simply plaster up to the line defined by the bead formation to give a particularly sharp/clean edge.

The EL wire 33 may be applied to the groove 32 before or after plastering, creating a very well defined edge to a wall structure. This is important since attention will be drawn to the defined edge upon illumination. In some installation methods, a string or other elongate member may be retained in the groove 32 during plastering, painting or the like. The string may be removed to allow insertion of the EL wire 33 thereafter. It is also possible to trap a sheet member, e.g. a thin plastic sheet in the groove 32 behind the string so as to provide a physical cover to prevent painting/plastering beyond the edge of the groove inadvertently. The sheet can be removed for insertion of the EL wire, e.g. once any paint or other decorative finish is set.

The frontal wall 28 comprises keying formations 36 along its length. The keying formations 36 comprise a plurality of grooves similar to the groove 32 and running substantially parallel therewith. However the grooves 36 do not receive light emitting wires in this example and instead receive the applied plaster to provide a strong mechanical lock with the plaster layer 34 once set. The keying formation 36 are thus covered in use, unlike the exposed groove 32 which holds the EL wire.

The front wall 16 of the recess 22 may also comprise keying formations for the applied plaster layer 34. However those formations are more conventional in form comprising lower depth/profile features such as shallow ridges or grooves or a textured surface. The deeper/larger grooves 36 and their curved profile provide a more aggressive mechanical key and an easier structure over which to plaster accurately. This is important with the reduced depth of plaster and the need to define a clean/sharp edge towards the distal edge 30.

A different keying formation 37 is also provided in the front wall 16 as shown in FIG. 3 in the form of holes. The holes 37 allow plaster to come into contact with the wall member 24 in recess 12 and thereby key with the bracket and wall member 42 itself.

In this example, a rear wall 38 of the second portion 14 is provided. The rear wall 38 is spaced form the frontal wall 28 by the intermediate wall 20 to define a channel 40, which in this example provides a lighting well. The channel is closed at its internal end but is open at its other end. The channel 40 may be conceptually likened to a mirror the recess 22. However the channel 40 and recess 22 are of different shape and are arranged for different functions.

The channel 40 defines an elongate cavity in which a further light source 42 can be mounted. In this example, the further light source 42 takes the form of a length of LED lights as shown in FIGS. 2 and 3. An LED ribbon/tape or strip may be used for this purpose including an addressable pixel lighting ribbon. Other light sources may be inserted in the channel 40 instead of LED lights if desired.

The function of the light source 42 is different from that of the EL wire 32. The purpose of the light source 42 is to provide lighting of a gap beyond the distal end of the wall 28, e.g. a shadow gap 46, rather than to provide a thin line of light defining the distal edge 30 (i.e. the function of the EL wire). As such the light source 42 may have greater light output (lumens) per unit length and/or may output light of different colour from that of the wire. The light source 42 may be controlled by a common controller with the EL wire 33.

A light diffusion member 44 (e.g. a light diffuser strip) is provided in this example in the channel 40. The light diffuser 44 is mounted spaced from the light source 42, e.g. part-way along the cannel 40 or towards an open end of the channel. The light diffuser is translucent and serves to alter the appearance of the light by a viewer, i.e. to avoid or lessen the appearance of individual lights and instead create a more uniform lighting effect along the length of the gap. The member 44 may also be referred to as a homogenizer for the discrete light sources.

Internal faces of the frontal wall 28 and/or rear wall 38 may comprise mounting formation for holding the diffuser 44 in place. In this example the mounting formation is a slot, e.g. a push fit slot, although an alternative abutment formation could be used. Opposing slots on the frontal 28 and rear 38 walls mean that the diffuser is securely held without the need for fasteners.

In the example of FIGS. 1-3, the rear wall 38 of the second portion 14 extends beyond the distal edge 30 of the frontal wall 28. The rear wall may thus extend into the shadow gap 46 in use and/or may define a lateral/width dimension of the shadow gap. However, more typically, a shadow gap may be narrower in width than the length of the rear wall such that the distal end of the rear wall 38 is hidden. This may be defined as a rebated arrangement and can accommodate expansion, movement, etc. in situ or other tolerance-related issues, such that a precisely defined end abutment is not needed.

As shown in FIG. 2, an opposing member 48 may be spaced from the distal edge 30 when the lighting system is mounted for use, thereby defining the shadow gap 46. The opposing member may be an adjacent skirting, door/window surround, wall, ceiling, floor, frame member, shelf, ledge or the like, depending on the context in which the edge lighting is being provided.

The protruding portion 38A of the rear wall 38 may comprise one or more mounting formations thereon. The protruding portion 38A may comprise one or more further groove 50, i.e. for receiving one or more optional further EL wire. The one or more further groove 50 may be laterally spaced from groove 32. The one or more further groove 50 may be parallel with the groove 50. In this way an edge can be further highlighted using parallel lines of light in the gap beyond the distal edge 30.

A rear face of the rear wall 38 may comprise a protrusion/abutment formation 52, which may be useful in ensuring the correct alignment/positioning of the bracket 10 in situ. The protrusion 52 runs the length of the bracket 10 in this example.

The profile of the bracket shown in FIGS. 1-3 also includes a plurality of slots 54, which are used for receiving a fastener for connecting adjoining lengths of bracket as will be described below. It can be seen that some slots are in a common orientation, whilst other slots are oriented perpendicular thereto. The slots 54 may be partially open, e.g. having a discontinuity therein, along one side. In this example a slot may be provided at any or any combination of the following locations: on intermediate wall 20, at a proximal end of the front wall 16; at a distal end of the real wall 18; part way along the rear wall 38 or its protruding portion 38A; and/or at a distal end of the protruding portion 38A of rear wall 38.

Turning now to FIGS. 4-6, there is shown how adjacent brackets 10 can be fastened together to form a wider system for illuminating a plurality of adjoining edges or associated shadow gaps.

In FIG. 4 there is shown the components of a fastener system for joining adjacent brackets at right angles. The fastener system may be referred to as a cleat connector and comprises a main fastener member 60 having first 60A and second 60B limbs.

Each limb 60A and 60B is arranged to be received in a slot 54 in the profile of a respective bracket. That is to say each limb 60A and 60B has a cross sectional profile which fits within the cross-sectional profile of the slots. In this regard, all slots are preferably of a common profile so the same fastener member can be selectively inserted into any one of the slots 54 as desired according to the intended joint to be formed.

The limbs 60A and 60B are angularly offset so as to suit the required angular orientation between the adjoining brackets when fastened together. In this example the limbs are perpendicularly oriented, although other angular orientations could be used if a non-right-angled connection is needed, such as an angle of 135° or a straight line connector at 180°.

Each limb may be tapered towards its distal end. Whilst not readily discernable from the drawings, each limb may have a slightly adverse taper part-way along its length, e.g. tapering laterally outwardly. This outward taper may help hold the limb in a respective slot 54 before being rigidly fastened in place.

Each limb 60A, 60B has a narrow/elongate aperture 62, e.g. a slit, running from its distal end part way along the limb. In this regard, the limbs are each bifurcated towards their distal end.

An opposing member 64 is arranged to be received within each limb's aperture 62 in order to fix the main fastener in place within its slot 54 in the bracket. The opposing member 64 comprises a body with an elongate tapered protrusion 66, which is shaped to be received in the aperture 62. Thus, as the protrusion 66 enters and moves along the aperture 62 in use, it biases the bifurcated limb outwards. The opposing/male member 64 may be located in a relevant slot 54 as a first step of an assembly process. The main/female fastener may be subsequently slid into the slot 54 and the opposing members may be locked together once the adjacent bracket members are correctly aligned.

The protrusion 66 has a head formation 68 at its tip. The aperture 62 has a correspondingly shaped cavity 70 (in this example, a series of cavities) towards its end to receive the head formation. As the head formation enters the corresponding cavity it clicks into place, providing a locking effect to resist removal of the opposing member 64 from the aperture 62.

Each of the main fastener member 60 and the opposing member 64 has an opening 72 therein. A crimping tool may be engaged with the openings 72 of the main fastener member 60 and opposing member 64 on order to force the two components together to cause the locking effect.

In this example, the main fastener 60 comprises a female part and the opposing member comprises a male part. However the opposite arrangement could of course be used. Also, the male part is tapered and the female part is straight edged in this example but any alternative tapering interface for biasing of the female part to lock it tightly within its slot could be used.

Turning to FIGS. 5 and 6, there is shown an example joint between adjacent brackets 10 that is fastened together using the fastening system of FIG. 4. Each of the brackets 10 are cut at the relevant angle at their respective ends, e.g. at 45°.

As the ends are brought into abutment, a main fastener member 60 is inserted into respective slots 54 in each of the brackets to be joined together. Opposing members 64 are slid along the respective slots to engage with the relevant limb of the main fastener member in the manner described above. The fasteners are then brought into a locked arrangement, e.g. using a crimping tool or similar.

Whilst only one fastener 60 is shown in FIGS. 5 and 6 for each joint, two or more fasteners 60 can, and typically would, be used for each joint. Different fasteners can be engaged in different slots 54 of the bracket members so as to act in parallel.

The main 60 and opposing 64 fastener members can beneficially be formed by cutting the relevant profiles from a sheet, e.g. by laser cutting.

Whilst the above-described embodiments concern a single bracket 10 profile, there are a variety of different installations that may require different bracket profiles as shown in FIGS. 7-11.

FIG. 7A shows an alternative bracket profile which is akin to the profile of FIG. 1 except that it has the rear wall 38 removed. This profile may be used where the shadow gap lighting 42 and associated diffuser 44 are not required, i.e. offering a simplified version of the bracket profile. An alternative shadow gap lighting arrangement could be installed behind the front wall 28 of this embodiment if desired. This profile may be used for arrangement against an adjacent member (not shown), e.g. with a silicone bead, or similar being used to bridge any small gap between the bracket and the adjacent member.

In FIG. 7B another profile of bracket member is shown with front and rear walls having distal ends that can form an end abutment against an adjacent member.

Whilst significant explanation has been given to the embodiment of FIGS. 1-3 since it contains additional optional lighting features, embodiments, which do not accommodate a shadow gap may be equally prevalent.

FIGS. 8-11 show bracket arrangements for various corner configurations. In these arrangements, the bracket is akin to a double-bracket with opposing halves joined at the groove 32. These brackets can receive wall member on opposing sides thereof so as to define a corner between those wall members. The angle of the corner in FIGS. 8-11 varies and further embodiments can be generated to suit different angular arrangement from those shown, including acute, obtuse, reflex angles. In the example of FIG. 11, the opposing halves of the double bracket are aligned along a straight line, i.e. defining a gap part way along a straight wall for illumination, e.g. as a purely aesthetic feature rather than at a corner or other architectural feature.

Turning to FIGS. 12-13, there is shown a schematic of the control system for the lighting system. The control system comprises a master controller 74 shown in FIG. 12 and a slave controller 76 for each section of the bracket and its associated light EL wire(s). Depending on the installation requirements, a section of the bracket may be an individual length of bracket, i.e. a single piece of the bracket, or else may comprise a plurality of pieces connected together. It is preferred that each individual length/piece of bracket has its own slave controller so as to provide maximum lighting options to the user.

The master controller 74 sends control instructions to the slave controllers 76 to illuminate the EL wire in use. In this way, the master controller can coordinate an order/sequence of illumination of the individual lengths of EL wire and/or concurrent lighting. The master controller can also control, e.g. directly, the individual lengths of LED lights (e.g. the shadow gap lighting), where used.

The master controller provides ancillary functions, such as communication with a local and/or wide area network for any or any combination of:
Initial programming and setup
Receiving user/operational instructions from remote devices
Monitoring system health and any feedback from slave controllers
Communicating health/operational status to remote devices

The master controller 74 may communicate with slave controllers 76 devices by wired or wireless communication means using conventional communication standards.

The master controller 74 receives sensor inputs such as motion/PIR sensor inputs and/or switch signals to determine when illumination of the EL wire and/or gap lighting is required.

EL wire typically requires a voltage of 50-100 v AC to energise the wire and cause it to emit light. Conventional control of EL wire uses a simple circuit comprising a rudimentary sine wave generator with the output amplified to drive a transformer at the required voltage. However the only adjustment generally available is to adjust the voltage of the circuit to adjust the brightness.

The control system for implementation of the present lighting as shown in FIGS. 12-13 offers improved functionality. It uses a microcontroller, e.g. at the master controller 74 in this example, to create the desired waveform (e.g. sine wave or pulse width modulation waveform) digitally. The data stream 78 is the output signal sent to the slave controller 76 for control of the EL wire. The optional further data stream 80 is for control of the gap lighting using the LED lights, e.g. via inter-integrated circuit, I2C.

The data stream 80 is converted at the slave controller 76 to an analogue signal with a digital-to-analogue converter 82. This is then amplified at amplifier 84 to drive the transformer 86 as shown in FIG. 13.

The software of the microcontroller is designed to allow adjustment of the amplitude as well as the frequency of the waveform which provides control of both the brightness as well as the colour of the luminescence of the EL wire 33.

The slave controllers 76 may be connected to a bus (e.g. I2C bus) which allows the master controller 74 to address any individual slave controller 76 in the group of slave controllers available to it. The software provides a range of routines to control the speed of change of brightness and subtle adjustment of colour of the EL wire. Having a separate/slave microcontroller for each EL wire offloads the processing of the sine wave from the master controller 74 and allows it to attend to other tasks.

Using the above described control arrangement, each EL wire or group of EL wires has its own circuit for the purpose of independent control, whilst being coordinated with the operation of other EL wires by the master controller 74.

The above described lighting systems provide a number of potential benefits, including the ability to define architectural edges precisely with light for a pleasing aesthetic effect. The lit edges can be animated by energizing the individual lengths of EL wire in sequence. This can be likened to ‘drawing’ or ‘sketching’ the room for a viewer. Different lengths of EL wire can be controlled independently to heighten this effect or other visual effects, e.g. by varying the on/off state of different EL wires, and/or by altering brightness or hue.

Further potential benefits of the physical design of the system are as follows:
1/ Securely contain electroluminescent wire flush within a plastered wall and be able to remove and refresh electroluminescent wire without adversely affecting plaster or decoration.
2/ The ability to light an architectural shadow gap profile with a hidden diffused LED tape, which can be serviced without affecting the plastered surface
3/ Custom cleat fasteners to align mitred joints of brackets precisely and o ensure a higher degree of installation accuracy
4/ The bracket profile design enables plaster to adhere directly to the profile, allowing a lightwell to occupy a space where plasterboard would usually reside. This feature enables a lightwell, an end stop and conduit runs on both convex and concave corners.
5/ The ability to drastically improve the accuracy of the decorator “cutting in” job, e.g. using a silicone or string paint bead prior to the EL wire fix.
6/ The system creates much more precise square and parallel internal plastered surfaces which always have a datum on all edges of each surface plain.
7/ The system creates a visible wireframe of an internal architectural space without overly illuminating it
8/ The system enables diffused back lite drop ceilings of only 25 mm depth or less, in contrast to conventional methods, which require significantly greater depth.

1. A lighting system comprising:
an elongate bracket having a recess having a rear wall, the recess arranged to receive an edge of a wall member in use such that the bracket extends along the edge of the wall member;
a groove extending along a length of the bracket and spaced from the rear wall by an intermediate wall; and
an electroluminescent wire extending along the length of the bracket at a position within the groove in front of the rear wall such that the electroluminescent wire is exposed in use.

2. The lighting system according to claim 1, where the electroluminescent wire is mounted along an end/edge portion of the bracket.

3. The lighting system according to claim 1, where the electroluminescent wire is held within the groove with an interference fit.

4. The lighting system according to claim 1, where the bracket comprises a facia extending from the recess and comprising an outer engagement surface configured to support a decorative surface material over the facia.

5. The lighting system according to claim 4, where the facia comprises one or more keying formations in a form of a textured surface and/or openings for receiving the decorative surface material.

6. The lighting system according to claim 1, where the bracket comprises a channel provided on an opposing side of the intermediate wall from the recess.

7. The lighting system according to claim 6, where one or more light is mounted within the channel so as to define a light well.

8. The lighting system according to claim 7, where the intermediate wall comprises a heat sink configured to dissipate heat from the one or more light.

9. The lighting system according to claim 7, where the channel is at least partially enclosed by a light diffuser.

10. A lighting system according to claim 1, wherein the rear wall extends from one side of the intermediate wall to an opposing side of the intermediate wall such that the intermediate wall is part way along a lateral dimension of the rear wall.

11. The lighting system according to claim 10, where the rear wall comprises at least one further groove configured to receive an electroluminescent wire.

12. The lighting system according to claim 1, where the bracket comprises a plurality of recesses for receiving an edge of a corresponding plurality of wall members in use, the electroluminescent wire interposed between the recesses.

13. The lighting system according to claim 12, where the recesses are angularly offset so as to receive wall members oriented at different angles.

14. The lighting system according to claim 13, where the electroluminescent wire is provided at an apex of a facia depending from each recess.

15. The lighting system according to claim 1, where the bracket comprises an extruded member to provide a substantially continuous cross-sectional profile.

16. The lighting system according to claim 1, where the bracket comprises a slot configured to receive a fastener member to provide a connection to an adjacent bracket.

17. The lighting system according to claim 16, where the slot is provided on the rear wall or intermediate wall, on one or more side of the recess, or on or behind a facia.

18. A lighting system according to claim 1, comprising a plurality of elongate brackets releasably connected via a fastener member, the fastener member comprising opposing ends each being received in one of the plurality of elongate brackets.

19. The lighting system according to claim 18, where the fastener member is arranged to receive an opposing engagement member, the engagement member being a snap/push fit with the fastener member.

20. The lighting system according to claim 19, where one of the fastener member and the engagement member comprises a slit and another is insertable therein.

21. The lighting system according to claim 19, where one of the fastener member and the engagement member comprises a head formation arranged to be received in a corresponding female formation in another of the fastener member and the engagement member.

22. The lighting system according to claim 1 comprising a plurality of said-brackets, each bracket having its own electroluminescent wire, and the lighting system further comprises a controller configured to provide independent control of respective electroluminescent wires of each of the plurality of brackets.

23. The lighting system according to claim 22, where the controller is configured to provide independent control signals for controlling each electroluminescent wire, the control signals comprising one or both of a variable frequency and an amplitude component for controlling one or both of a color and a brightness of illumination of the electroluminescent wire respectively.

24. The lighting system according to claim 22, where the controller is configured to illuminate the respective electroluminescent wires in sequence.

25. The lighting system according to claim 22, where the controller comprises a master controller and each bracket comprises a slave controller arranged to implement illumination of the electroluminescent wire of its bracket based on control signals received from the master controller.
